(19) United States
(12) Patent Application Publication
(10) Pub. No.: US 2025/0358473 A1
(43) Pub. Date: Nov. 20, 2025

(54) DETERMINING VIDEO BITRATE FOR VIDEO STREAMING

(71) Applicants: Lemon Inc., Grand Cayman (KY); Beijing Zitiao Network Technology Co., Ltd., Beijing (CN)

(72) Inventors: Aoyang ZHANG, Beijing (CN); Wei HE, Beijing (CN); Shenglan HUANG, Los Angeles, CA (US); Liyang SUN, Beijing (CN); Zhendong ZHONG, Beijing (CN); Pengcheng CHEN, Beijing (CN); Mingkui LIU, Culver City, CA (US); Qian MA, Beijing (CN)

(21) Appl. No.: 19/207,118

(22) Filed: May 13, 2025

Related U.S. Application Data
(63) Continuation of application No. PCT/CN2024/093185, filed on May 14, 2024.

(51) Int. Cl. H04N 21/437; H04N 21/433; H04N 21/442; H04N 21/466

(52) U.S. Cl. CPC H04N 21/437; H04N 21/4331; H04N 21/44204; H04N 21/4662

(57) ABSTRACT

Methods and systems for determining a bitrate for a video to be streamed and controlling a buffer for streaming the video are disclosed. One example method includes receiving, from a streaming service, a predicted playback speed of a video to be played on the device and a probability of the predicted playback speed, wherein the predicted playback speed is determined based on a plurality of video playback speeds of a plurality of videos played by the user, and the probability of the predicted playback speed comprises a probability that the user will change a playback speed of the video from a first playback speed to the predicted playback speed during a playback of the video; determining, based on the predicted playback speed, a version of the video to be provided to the device; and sending, to the streaming service, a request to stream the version of the video.

### CLAIM OF PRIORITY

This application claims priority under 35 USC § 120 to International Patent Application Serial No. PCT/CN2024/093185, filed on May 14, 2024, the entire contents of which are hereby incorporated by reference.

### BACKGROUND

This specification relates to determining video bitrate for video streaming.

To satisfy preferences of different users of a video streaming service, as well as the capabilities of user devices and associated computer networks, a video can be transcoded into multiple resolutions and video bitrates. Higher network bandwidth and/or higher user device performance may be needed to support the playback of videos with higher bitrates. On the other hand, lower video bitrate can lead to smoother but relatively lower resolution video playback.

### SUMMARY

This specification is generally directed to techniques for determining a bitrate for a video to be streamed and controlling a buffer for streaming the video. One example method includes determining a predicted playback speed of the video. The predicted playback speed is determined based on historical video playback information of a user and characteristics of a video being played or to be played on a device of the user. The predicted playback speed represents a probability that the user will change from a normal playback speed to the predicted playback speed during the playback of the video. The historical video playback information can include the playback speeds, content categories, and/or durations of videos the user played during a particular period of time. The characteristics of the video being played or to be played can include the content category and/or the duration of the video.

The predicted playback speed and its associated probability are then used to determine, at the beginning of the playback of the video and from bitrates of the video available at a video streaming service, a bitrate of the video for streaming the video. The determined bitrate can be sent from the device of the user to the video streaming service to request a version of the video that corresponds to the selected bitrate. The predicted playback speed and its associated probability can also be used to control a buffer for streaming the video during the playback of the video, such that there is a proper amount of video cached in the buffer based on the user's historical preference of video playback speed, resulting in improved streaming experience of the user.

In general, one innovative aspect of the subject matter described in this specification can be embodied in methods that include the actions of receiving, by a device of a user and from a streaming service, a predicted playback speed of a video to be played on the device and a probability of the predicted playback speed, wherein the predicted playback speed is determined based on a plurality of video playback speeds of a plurality of videos played by the user, and the probability of the predicted playback speed comprises a probability that the user will change a playback speed of the video from a first playback speed to the predicted playback speed during a playback of the video; determining, by the device and based on the predicted playback speed, a version of the video to be provided to the device; and sending, by the device and to the streaming service, a request to stream the version of the video. Other embodiments of this aspect include corresponding computer systems, apparatus, and computer programs recorded on one or more computer storage devices, each configured to perform the actions of the methods.

This specification uses the term “configured” in connection with systems, apparatus, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

The subject matter described in this specification can be implemented in particular embodiments so as to realize one or more of the following advantages. The techniques described in this specification can lead to a better overall video playback experience for the users by more accurately matching the video consumption rate with the user's preference of video playback speed. The enhanced user experience can result in longer streamed video duration of videos of a video streaming system on user devices.

It is appreciated that methods in accordance with the present disclosure can include any combination of the aspects and features described herein. That is, for example, apparatus and methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description, drawings, and claims.

Implementations of the present disclosure are described in further detail herein with reference to an example use case. The example use case includes determining a resolution of a video to be downloaded for playback on a device of a user. It is contemplated, however, that implementations of the present disclosure can be realized with any appropriate use case.

### BRIEF DESCRIPTION OF DRAWINGS

FIG. 1 illustrates an example system for video streaming.

FIG. 2 illustrates an example process of determining a bitrate for a video to be streamed and controlling a buffer for streaming the video.

FIG. 3 illustrates an example process of determining the bitrate for video streaming.

FIG. 4 is a schematic illustration of example computer systems that can be used to execute implementations of the present disclosure.

Like reference numbers and designations in the various drawings indicate like elements.

### DETAILED DESCRIPTION

Users of a video streaming service can choose to stream a video at various playback speeds, depending on factors such as the video content category and/or the video duration. The video streaming service, can be for example, an online social media system or platform that provides video content to account holders, e.g., as part of a video feed. The different playback speeds can lead to varying streaming experience of the user, for example, when the playback speed exceeds the video streaming rate and when the buffer of the user device uses to stream the video is empty, the video playback can stall or be in a rebuffering mode, resulting in unsatisfactory streaming experience.

This specification relates to methods and systems for improving user experience of video playback during streaming of video content, for example, by selecting a bitrate for a video to be streamed and controlling a buffer for streaming the video, based, for example, on the predicted playback speed of the video determined from historical data of playback speeds for videos previously played by the user, as well as the video content categories and video durations associated with both the previously played videos and the to be played video. The selected bitrate can be sent to the video streaming service to request a version of the video that corresponds to the selected bitrate. The buffer of the user device can also be controlled based on the predicted video playback speed of the video, such that there is a proper amount of video cached in the buffer based on the user's historical preference of video playback speed, resulting in improved streaming experience of the user.

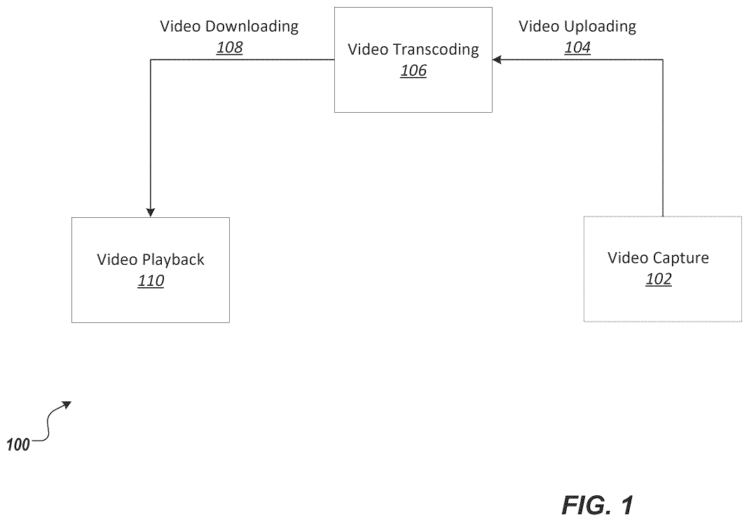

FIG. 1 illustrates an example system 100 for video streaming. At 102, a user, for example, a first user, records or captures a video using a video recording device such as a camera of a user device. The user device can be any Internet-connected computing device, e.g., a laptop or desktop computer, a smartphone, or an electronic tablet. The user device can be connected to the Internet through a mobile network, through an Internet service provider (ISP), or otherwise. Each user device is configured with software, which will be referred to as a client or as client software, that in operation can access the streaming service so that a user can interact with the streaming service. For example, the user can use the client software to upload video content to the streaming service as well as receive videos from the streaming service. The client software can be a specific application of the streaming service installed on the user device. The streaming service can be, for example, an online social media platform.

In some implementations, the client software provides a user interface for interacting with the streaming service. The user interface can include receiving data from the streaming service for presenting a feed of videos that the user can interact with. For example, the user can scroll up or down to switch between videos in the feed as well as interact with individual videos, e.g., by posting comments about the video, sharing the video, or expressing approval, e.g., liking the video.

In some implementations, the video content provided by the streaming service to user devices are short-form videos. Short-form videos are videos that are typically less than 90 seconds in length. In some implementations, short-form videos have lengths of between 15 and 90 seconds. By contrast, long-form videos typically have lengths of at least 3 minutes.

At 104, the first user uploads the video to the streaming service. The streaming service can include many different components for transcoding received video content, storing the transcoded version, and selecting video content to provide to recipient users. The streaming service can also include for example, a content delivery network (CDN) that includes a geographically distributed group of devices that provide content to end user devices. For clarity, FIG. 1 focuses only on the transcoding of uploaded video files and subsequent delivery to user device.

At 106, the server transcodes the obtained video file to generate multiple versions of the video file, each having a particular resolution/bitrate combination. Example resolutions of the transcoded videos can include 540p, 720p, and/or 1080p, where “p” stands for “progressive scan,” a scan mode of a transcoded video, as well as 2k and 4k, where “k” refers to an approximate number of horizontal pixels. Different resolutions can have the same bitrate, e.g., 2.4 Mbps, or different bitrates. Additionally, different versions can have the same resolution but different bitrates. The collection of transcoded versions for a given video can be referred to as a video ladder. Once the video has been transcoded into multiple versions, the versions are stored, e.g., as video ladders in a video storage. The video storage may be a distributed storage among multiple storage devices. Further, the video storage may be replicated in multiple locations such that multiple copies of the versions are stored, e.g., in multiple datacenters. In some implementations, sets of video ladders are cached in different devices of the CDN.

At 108, a particular transcoded version of the video from the multiple transcoded videos is selected and provided to a device of a user, for example, a second user. The video can be provided to the device of the second user, for example, in response to a request for video content received by the streaming service. As described below, the system of the streaming service determines a particular version of each video to provide to the device, e.g., for playback. At 110, the device of the second user plays back the video content.

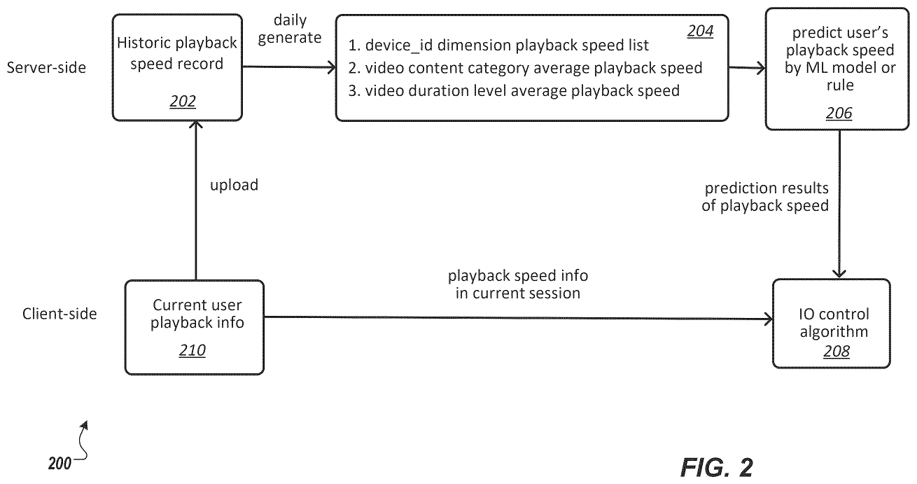

FIG. 2 illustrates an example process 200 of determining a bitrate for a video to be streamed and controlling a buffer for streaming the video. For convenience, the process 200 will be described as being performed by a system of one or more computers, located in one or more locations, and programmed appropriately in accordance with this specification. For example, a streaming system, e.g., an online social media platform and user devices coupled to the online social media platform, appropriately programmed, can perform the process 200. Another example of the streaming system is system 100 in FIG. 1, where the streaming service and the second user can perform the process 200.

At 202, a streaming service, for example, a server providing video streaming service to user devices, receives from a device of a user, historical record of video playback speeds of videos played by the user. An example of the user is the second user described in FIG. 1. In some implementations, the historical record can include the video playback speeds of the videos played by the user within a predetermined period of time, for example, within the last seven days. Example video playback speeds can include normal speed (i.e., one-time speed), double speed (i.e., two-times speed), etc. Each video playback speed in the historical record can be normalized against the normal speed and stored in the historical record as a numerical value, for example, 1.0 for the normal speed and 2.0 for the double speed.

In some implementations, the historical record can also include characteristics of each video associated with a respective video playback speed stored in the historical record, for example, the video content category and/or duration of the video. Example video content categories can include comedy, education, entertainment, music, sports, travel, etc. In some cases, the video content category can be provided by the user who uploaded the video (e.g., the first user described in FIG. 1) or the streaming service. In some cases, the duration of the video can be represented by duration levels, for example, duration level 1 for video durations not exceeding ten seconds, duration level 2 for video durations between ten seconds and twenty seconds, etc.

In some implementations, the historical record also includes the video playback speed of a video currently being streaming by the user, as well as characteristics (e.g., video content category and/or video duration) of the video.

At 204, the streaming service generates features of the historical video playback speed of the user, based on the historical record. The generated features (also referred to as playback speed portrait of the user) can represent the user's historical preference in video playback speed, depending on video category and/or video duration. For example, the streaming service can generate a list of the video playback speeds of videos played by the user within the predetermined period of time. In some cases, the streaming service can also generate an average playback speed for a video content category and/or a video duration level in the historical record.

An example of the features generated at 204 can include a series of features each having three variables respectively representing a playback speed, a content category, and a duration level. An example set of features can be: [(1.0, category 1, duration level 1), (2.0, category 3, duration level 2), (2.0, category 5, duration level 1), (1.0, category 7, duration level 2), (2.0, category 3, duration level 1), (1.0, category 4, duration level 1)], where the first variable in each individual feature set represents the average video playback speed for a specific video content category and a specific video duration level, the second variable represents the video content category corresponding to the average video playback speed in the first variable, and the third variable represents the video duration level corresponding to the average video playback speed in the first variable.

In some implementations, the streaming service can generate the features, at 204, at predefined time instances or periodically, for example, on a daily basis, to include the video playback speeds and the associated characteristics (e.g., video content categories and/or video durations) of the videos played by the user within the predetermined period of time, up to the video currently being played by the user.

At 206, the streaming service predicts the playback speed of the video currently being played or to be played on the device of the user, as well as the probability of the predicted playback speed, based on the features (i.e., the playback speed portrait of the user) generated at 204 and the characteristics (e.g., video content category and/or video duration) of the video currently being played or to be played by the user. In some implementations, the probability of the predicted playback speed can represent the probability that the playback speed will be changed by the user during the playback of the video from a normal speed (i.e., one-time speed) to the predicted playback speed (e.g., two-times speed).

In some implementations, the streaming service can first calculate, for each playback speed in the features generated at 204, the average probability of a video having the playback speed and also having the characteristics of the video currently being played or to be played. Then the streaming service can select the playback speed having the highest average probability as the predicted playback speed of the video currently being played or to be played by the user on the device of the user. The highest average probability then represents the probability of the user using the selected playback speed to play the video.

For example, referring to the aforementioned example of the features that has six individual feature sets, if the video currently being played or to be played has category 3 and duration level 1, then the streaming service can calculate the probability of a video having playback speed of 2.0 and category 3 to be 2/2, which is 100%. Then the streaming service can calculate the probability of a video having playback speed of 2.0 and duration level 1 to be 2/4, which is 50%. Next the streaming service can calculate the average probability of a video having playback speed of 2.0 to be (100%+50%)/2, which is 75%. In some cases, weighting factors can be used to weigh each component (e.g., 100% and 50% in the aforementioned example) in the calculation of the average probability.

Similarly, the streaming service can calculate the average probability of a video having playback speed of 1.0. Then the streaming service can determine that the average probability of a video having playback speed of 2.0 is higher than the average probability of a video having playback speed of 1.0, for the aforementioned example. Therefore, the predicted playback speed in the aforementioned example and for the video (with category 3 and duration level of 1) currently being played or to be played is 2.0, with a probability of 75%.

In some implementations, the streaming service can also predict the playback speed using a trained machine learning (ML) model. The input to the ML model are also the features (i.e., the playback speed portrait of the user) generated at 204 and the characteristics (e.g., video content category and/or video duration) of the video currently being played or to be played by the user. The output of the ML model is the playback speed and the probability in the features that has the highest probability predicted by the ML model. For example, an output of (2.0, 0.75) represents a playback speed of 2× normal and a change probability of 75 percent. The example ML model can be a tree model or a neural network (NN) model.

At 208, the device of the user receives from the streaming service, the predicted playback speed generated by the streaming service at 206. The device of the user also receives the playback information of the video currently being played on the device, for example, the bitrate of the current video being played, the estimated time to play the current video (e.g., video duration of the current video being played), and/or the bandwidth of the user's network. The device of the user then determines, based on the predicted playback speed and the playback information of the video currently being played, a duration of a portion of the video to be cached in the buffer of the device for future playback (also referred to as video blocks), in order to reduce rebuffering and/or stalls of the current video. In some implementations, the duration of the portion of the current video to be cached in the buffer is a difference between a target buffer duration and a current buffer duration, where the target buffer duration is determined based on, among other things, the speed of the user's network and the bitrate of the video currently being played, as shown in Equations 1 to 4 below, and the current buffer duration represents the duration of the video currently cached in the buffer. For example, if the target buffer duration is 20 seconds and the currently cached video duration is 15 seconds, the duration of the portion of the video to be cached in the buffer is 5 seconds.

In some implementations, if the video is played at a speed higher than the normal speed, for example, two-times speed, the playback consumption speed can be twice the normal playback consumption speed, and the corresponding target buffer duration can increase. According to the predicted playback speed and the associated probability determined at 206, the device of the user can determine the amount of video data consumed by the user in the buffer per unit time (i.e., buffer consumption rate).

Examples of the calculation of the target buffer duration are shown in Equations of 1 to 4, and an example of the calculation of the duration of the portion of the video to be cached in the buffer (also referred to as video blocks) is shown in Equation 5, where target Buffer represents the target buffer duration, currentBuffer represents the duration of the video currently in the buffer, currentestPlayTime represents the estimated time to play the video (also referred to as video duration), videoBitrate represents the bitrate of the current video, bandwidth represents the current bandwidth of the user's network, playbackSpeed represents the predicted playback speed from 206, and changeProbability represents the probability of the predicted playback speed determined by the streaming service at 206.

targetBuffer*videoBitrate=estPlayTime*videoBitrate(estPlayTime/playbackSpeed)*Bandwidth (1)

targetBuffer=estPlayTime*(videoBitrate−Bandwidth/playbackSpeed)/videoBitrate (2)

targetBuffer=(1−Bandwidth/(videoBitrate*playbackSpeed*changeProbability))estPlayTime (3)

targetBuffer=(1−Bandwidth/(playbackSpeed*playbackSpeed*changeProbability))*estPlayTime (4)

videoBlock=targetBuffer−currentBuffer (5)

At 208, the device of the user can also predict a bitrate for a video to be played on the device of the user, based on the predicted playback speed and the playback information of the video to be played. In some implementations, this determination of the bitrate is at the beginning of the playback of the video. Given the predicted playback speed from 206, the video duration consumed per unit time can be the predicted playback speed times the video duration consumed per unit time at the normal playback speed. Therefore, the predicted video bitrate can be the predicted playback speed multiplied by the bitrate of the video playing at the normal playback speed, as shown in Equation 6 below.

predicted_video_bitrate=playbackSpeed*original_bitrate (6)

In some implementations, the device of the user can send the predicted bitrate to the streaming service to request a version of the video to be played on the device of the user, where the version of the video corresponds to the predicted bitrate from 208. Because the predicted bitrate takes into account the predicted playback speed of the video to be played, and the predicted playback speed is determined at 206 based on the historical record of the user that captures the user's preferred playback speeds for different video content categories and video duration levels, the predicted bitrate from 208 can help reduce the rebuffering and/or stalls of the video playback, and consequently improve the user experience in video playback.

At 210, the device of the user can add the playback information of the video currently being played or to be played to current user playback information, which can be provided, as part of the historical record of video playback information, to the streaming service, as described above with 202.

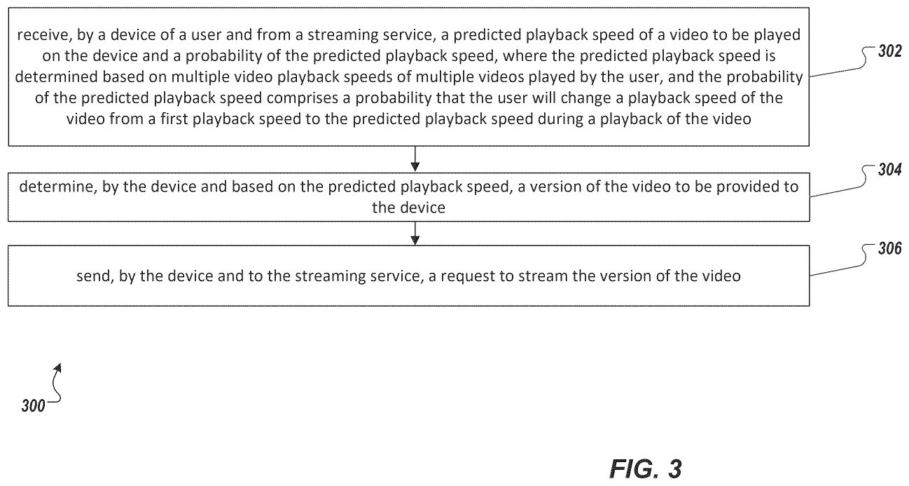

FIG. 3 illustrates an example process 300 of determining video bitrate for video streaming. For convenience, the process 300 will be described as being performed by a system of one or more computers, located in one or more locations, and programmed appropriately in accordance with this specification. For example, a streaming system, e.g., an online social media platform and user devices coupled to the online social media platform, appropriately programmed, can perform the process 300. Another example of the streaming system is system 100 in FIG. 1, where the streaming service and the second user can perform the process 300.

At 302, a system receives a predicted playback speed of a video to be played on a device of a user, where the predicted playback speed is determined based on multiple video playback speeds of multiple videos played by the user.

At 304, the system determines, based on the predicted playback speed, a version of the video to be provided to the device.

At 306, the system sends a request to stream the version of the video.

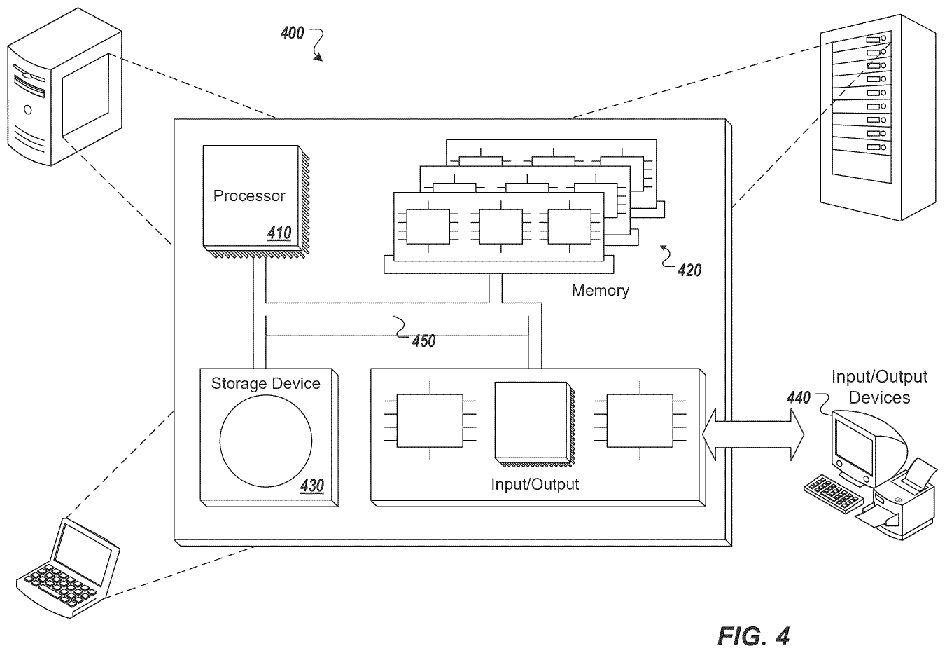

FIG. 4 illustrates a schematic diagram of an example computing system 400. The system 400 can be used for the operations described in association with the implementations described in this specification. For example, the system 400 may be included in any or all of the server components discussed above. The system 400 includes a processor 410, a memory 420, a storage device 430, and an input/output device 440. The components 410, 420, 430, and 440 are interconnected using a system bus 450. The processor 410 is capable of processing instructions for execution within the system 400. In some implementations, the processor 410 is a single-threaded processor. The processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is one or more computer-readable media. The memory 420 can be a volatile memory unit or a non-volatile memory unit. The storage device 430 is capable of providing mass storage for the system 400. The storage device 430 is a computer-readable medium. The storage device 430 may be a floppy disk device, a hard disk device, an optical disk device, or a tape device. The input/output device 440 provides input/output operations for the system 400. The input/output device 440 includes a keyboard and/or pointing device. The input/output device 440 includes a display unit for displaying graphical user interfaces.

In addition to the embodiments of the attached claims and the embodiments described above, the following embodiments are also innovative:

Embodiment 1 is a computer-implemented method comprising: receiving, by a device of a user and from a streaming service, a predicted playback speed of a video to be played on the device and a probability of the predicted playback speed, wherein the predicted playback speed is determined based on a plurality of video playback speeds of a plurality of videos played by the user, and the probability of the predicted playback speed comprises a probability that the user will change a playback speed of the video from a first playback speed to the predicted playback speed during a playback of the video; determining, by the device and based on the predicted playback speed, a version of the video to be provided to the device; and sending, by the device and to the streaming service, a request to stream the version of the video.

Embodiment 2 is the computer-implemented method of embodiment 1, wherein the method further comprises: before receiving, by the device and from the streaming service, the predicted playback speed, generating, by the streaming service and based on features of the plurality of videos played by the user and a plurality of characteristics of the video, the predicted playback speed of the video.

Embodiment 3 is the computer-implemented method of any one of embodiments 1 through 2, wherein the plurality of characteristics of the video comprises a video content category of the video or a video duration of the video.

Embodiment 4 is the computer-implemented method of any one of embodiments 1 through 3, wherein generating the predicted playback speed of the video comprises: determining, among the plurality of video playback speeds and as the predicted playback speed, a playback speed having the highest probability of the user using the playback speed to play the video.

Embodiment 5 is the computer-implemented method of any one of embodiments 1 through 4, wherein generating the predicted playback speed of the video comprises generating the predicted playback speed using a machine learning (ML) model.

Embodiment 6 is the computer-implemented method of any one of embodiments 1 through 5, wherein the method further comprises: after sending the request to the streaming service to stream the version of the video, determining, based on the predicted playback speed of the video, a duration of a portion of the video to be cached in a buffer of the device.

Embodiment 7 is the computer-implemented method of any one of embodiments 1 through 6, wherein the version of the video corresponds to a bitrate of the video.

Embodiment 8 is a system comprising: one or more computers and one or more storage devices storing instructions that are operable, when executed by the one or more computers, to cause the one or more computers to perform the method of any one of embodiments 1 to 7.

Embodiment 9 is a computer storage medium encoded with a computer program, the program comprising instructions that are operable, when executed by data processing apparatus, to cause the data processing apparatus to perform the method of any one of embodiments 1 to 7.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method comprising:
receiving, by a device of a user and from a streaming service, a predicted playback speed of a video to be played on the device and a probability of the predicted playback speed, wherein the predicted playback speed is determined based on a plurality of video playback speeds of a plurality of videos played by the user, and the probability of the predicted playback speed comprises a probability that the user will change a playback speed of the video from a first playback speed to the predicted playback speed during a playback of the video;
determining, by the device and based on the predicted playback speed, a version of the video to be provided to the device; and
sending, by the device and to the streaming service, a request to stream the version of the video.

2. The computer-implemented method of claim 1, wherein the method further comprises:
before receiving, by the device and from the streaming service, the predicted playback speed, generating, by the streaming service and based on features of the plurality of videos played by the user and a plurality of characteristics of the video, the predicted playback speed of the video.

3. The computer-implemented method of claim 2, wherein the plurality of characteristics of the video comprises a video content category of the video or a video duration of the video.

4. The computer-implemented method of claim 2, wherein generating the predicted playback speed of the video comprises:
determining, among the plurality of video playback speeds and as the predicted playback speed, a playback speed having the highest probability of the user using the playback speed to play the video.

5. The computer-implemented method of claim 4, wherein generating the predicted playback speed of the video comprises generating the predicted playback speed using a machine learning (ML) model.

6. The computer-implemented method of claim 1, wherein the method further comprises:
after sending the request to the streaming service to stream the version of the video, determining, based on the predicted playback speed of the video, a duration of a portion of the video to be cached in a buffer of the device.

7. The computer-implemented method of claim 1, wherein the version of the video corresponds to a bitrate of the video.

8. A system comprising:
one or more computers and one or more storage devices on which are stored instructions that are operable, when executed by the one or more computers, to cause the one or more computers to perform operations comprising:
receiving, by a device of a user and from a streaming service, a predicted playback speed of a video to be played on the device and a probability of the predicted playback speed, wherein the predicted playback speed is determined based on a plurality of video playback speeds of a plurality of videos played by the user, and the probability of the predicted playback speed comprises a probability that the user will change a playback speed of the video from a first playback speed to the predicted playback speed during a playback of the video;
determining, by the device and based on the predicted playback speed, a version of the video to be provided to the device; and
sending, by the device and to the streaming service, a request to stream the version of the video.

9. The system of claim 8, wherein the instructions are further operable to cause the one or more computer to perform operations comprising:
before receiving, by the device and from the streaming service, the predicted playback speed, generating, by the streaming service and based on features of the plurality of videos played by the user and a plurality of characteristics of the video, the predicted playback speed of the video.

10. The system of claim 9, wherein the plurality of characteristics of the video comprises a video content category of the video or a video duration of the video.

11. The system of claim 9, wherein generating the predicted playback speed of the video comprises:
determining, among the plurality of video playback speeds and as the predicted playback speed, a playback speed having the highest probability of the user using the playback speed to play the video.

12. The system of claim 11, wherein generating the predicted playback speed of the video comprises generating the predicted playback speed using a machine learning (ML) model.

13. The system of claim 8, wherein the instructions are further operable to cause the one or more computer to perform operations comprising:
after sending the request to the streaming service to stream the version of the video, determining, based on the predicted playback speed of the video, a duration of a portion of the video to be cached in a buffer of the device.

14. The system of claim 8, wherein the version of the video corresponds to a bitrate of the video.

15. One or more computer-readable storage media encoded with instructions that, when executed by one or more computers, cause the one or more computers to perform operations comprising:
receiving, by a device of a user and from a streaming service, a predicted playback speed of a video to be played on the device and a probability of the predicted playback speed, wherein the predicted playback speed is determined based on a plurality of video playback speeds of a plurality of videos played by the user, and the probability of the predicted playback speed comprises a probability that the user will change a playback speed of the video from a first playback speed to the predicted playback speed during a playback of the video;
determining, by the device and based on the predicted playback speed, a version of the video to be provided to the device; and
sending, by the device and to the streaming service, a request to stream the version of the video.

16. The computer-readable storage media of claim 15, wherein the instructions, when executed, further cause the one or more computers to perform operations comprising:
before receiving, by the device and from the streaming service, the predicted playback speed, generating, by the streaming service and based on features of the plurality of videos played by the user and a plurality of characteristics of the video, the predicted playback speed of the video.

17. The computer-readable storage media of claim 16, wherein the plurality of characteristics of the video comprises a video content category of the video or a video duration of the video.

18. The computer-readable storage media of claim 16, wherein generating the predicted playback speed of the video comprises:
determining, among the plurality of video playback speeds and as the predicted playback speed, a playback speed having the highest probability of the user using the playback speed to play the video.

19. The computer-readable storage media of claim 18, wherein generating the predicted playback speed of the video comprises generating the predicted playback speed using a machine learning (ML) model.

20. The computer-readable storage media of claim 15, wherein the instructions, when executed, further cause the one or more computers to perform operations comprising:
after sending the request to the streaming service to stream the version of the video, determining, based on the predicted playback speed of the video, a duration of a portion of the video to be cached in a buffer of the device.
